(19) United States
(12) Patent Application Publication
(10) Pub. No.: US 2022/0307606 A1
(43) Pub. Date: Sep. 29, 2022

(54) SELECTABLE FLUID COUPLER

(71) Applicants: David WEISER, Watertown, MA (US); Alex GOLDBLATT, Winchester, MA (US); Espir KAHATT, Carlsbad, CA (US); Ben REISMAN, Encinitas, CA (US)

(72) Inventors: David WEISER, Watertown, MA (US); Alex GOLDBLATT, Winchester, MA (US); Espir KAHATT, Carlsbad, CA (US); Ben REISMAN, Encinitas, CA (US)

(21) Appl. No.: 17/703,515

(22) Filed: Mar. 24, 2022

Related U.S. Application Data
(60) Provisional application No. 63/167,206, filed on Mar. 29, 2021.

(51) Int. Cl. F16K 1/36; F16K 1/42; F16K 7/16; F16K 17/20; F16K 25/04; F16K 27/02; F16K 31/122; F16K 41/10; F16K 41/12

(52) U.S. Cl. CPC F16K 1/36; F16K 1/42; F16K 7/16; F16K 17/20; F16K 25/04; F16K 27/02; F16K 31/1221; F16K 41/103; F16K 41/12

(57) ABSTRACT

A rotary valve may be operated by automated means and permits aseptic coupling of a source fluid conduit to any of a few or many possible outlet conduits. The valve assembly may be provided with numerous connectors for output coupling but it is not necessary to connect tubing to all of them.

### CROSS-REFERENCE TO RELATED APPLICATION

This application claims priority to and the benefit of, and incorporates herein by reference in its entirety, U.S. Ser. No. 63/167,206, filed on Mar. 29, 2021, the entire disclosure of which is hereby incorporated by reference.

### FIELD OF THE INVENTION

The present invention relates, generally, to fluid transport and connections among fluid conduits in biological production processes.

### BACKGROUND

Biopharmaceuticals and vaccines are commonly produced using a series of operations intended to express, recover, and stabilize proteins or other pharmaceutical ingredients as part of a manufacturing process. These operations involve the delivery, transfer and disposal of one or more fluid media and buffers comprising combinations of salts, chemicals, and other substances intended to support specific steps in the production process. Examples of such operations include cell cultivation or fermentation, buffer exchange, chromatography, concentration, precipitation, and crystallization. For biopharmaceuticals and vaccines, the assurance of aseptic transfer and processing is also important.

Common means of storing and transferring these fluids in a single operation or in multiple operations involve conduits or pipes to deliver the fluids from one location, such as a storage tank, to another. Any single operation among the plurality of steps required for manufacturing can require transfer of different reagents along different fluid paths. In total, the unique number of fluid-carrying conduits can range from two to 20 to 100 or more.

Disposable fluidic conduits can reduce the chemical waste required for cleaning fixed conduits between operations, improve the assurance of aseptic operations, and reduce the time required to build new manufacturing sites or processes for new pharmaceutical ingredients. These disposable fluidic conduits often comprise biocompatible materials such as silicone tubing or other plastics. The conduits often are customized in length and terminal connections to connect different equipment in the process. The connections may include direct connections to other disposable components such as bags or containers or adaptable connectors designed to allow aseptic connection to another conduit. In this way, a set of assembled conduits can be connected to allow for the connectivity of the plurality of fluids and transfers required for one or more operations of bioprocessing.

The components needed for a particular application may include tubes, connectors, bags, valves and the like, and these basic elements may be assembled into complex fluid-transfer systems as needed to effect the various operational stages of the application. The more versatile the means of creating interconnections among fluid components, the more efficient, rapid and flexible the assembly of diverse system configurations can be. Hence, there is a need for aseptic connectors that enable selectable connections among a plurality of fluid conduits.

### SUMMARY

Embodiments of the present invention utilize a rotary valve that may be operated by automated means and permits aseptic coupling of a source fluid conduit to any of a few or many possible outlet conduits. The valve assembly may be provided with numerous connectors for output coupling but it is not necessary to connect tubing to all of them.

Accordingly, in a first aspect, the invention relates to valve assembly comprising, in various embodiments, a support, an input fluid conduit passing through the support and terminating therein at a multiposition valve head, and a plurality of output fluid conduits emanating from and individually selectable by the valve head for coupling to the input fluid conduit. The valve head comprises a rotatable member and a clamp seated within the support. The rotatable member is rotatable within the clamp over a fixed angular extent, and various angular positions of the rotatable member each couple the input fluid conduit to a different one of the output fluid conduits.

In various embodiments, a surface seal surrounds a peripheral edge of the clamp where it meets the support. The rotatable member may include a rigid engagement member and, affixed thereto, an elastomeric distributor including a recessed coupling channel for coupling the input fluid conduit to a selected output fluid conduit. In some embodiments, the rotatable member and the elastomeric distributor include complementary raised and recessed (e.g., off-round, such as star-shaped or polygonal) features to prevent relative rotation therebetween.

The engagement member may include a plurality of arcuate engagement ribs. Also, the rotatable member and the clamp may include complementary engagement features for stopping rotation of the rotatable member at a fixed position, e.g., no more than a single revolution. Typically, the valve assembly will include coupling members for coupling elastomeric tubes to the input and output fluid conduits.

In another aspect, the invention pertains to a method of establishing fluid communication between a selected pair of elastomeric fluidic tube conduits. In various embodiments, the method comprises providing a valve assembly including a support, a coupling member for an input fluid conduit passing through the support and terminating therein at a multiposition valve head, and coupling members for a plurality of output fluid conduits emanating from and individually selectable by the valve head for coupling to the input fluid conduit, wherein the valve head comprises a rotatable member and a clamp seated within the support. The method may include coupling a first fluidic tube conduit to the input coupling member, coupling a second fluidic tube conduit to a selected one of the output fluid conduit coupling members, rotatively engaging an operating unit with the rotatable member, rotating—by the operating unit—the rotatable member to an angular position coupling the input fluid conduit to the selected output fluid conduit, and causing transfer of a fluid from the first fluidic tube conduit to the second fluidic tube conduit via the valve assembly. The valve assembly may include various of the features mentioned above.

As used herein, the term “approximately” means ±10%, and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

The foregoing and the following detailed description will be more readily understood when taken in conjunction with the drawings, in which:

FIG. 1A is a top perspective view of a selectable fluid coupler in accordance with embodiments of the invention.

FIG. 1B is a bottom perspective view of the selectable fluid coupler shown FIG. 1A without a backplate.

FIGS. 2A and 2B are partially transparent top and bottom plan views, respectively, of the selectable fluid coupler shown in FIGS. 1A and 1B.

FIG. 3 is a sectional elevation of the selectable fluid coupler shown in FIGS. 1A-2B.

FIG. 4 shows exploded and assembled side views of a rotary valve head in accordance with embodiments of the invention.

FIGS. 5A and 5B are exploded views of the rotary valve head shown in FIG. 4.

FIGS. 6A and 6B are partially transparent top and bottom plan views, respectively, illustrating operation of the selectable fluid coupler shown in FIGS. 1A and 1B.

### DETAILED DESCRIPTION

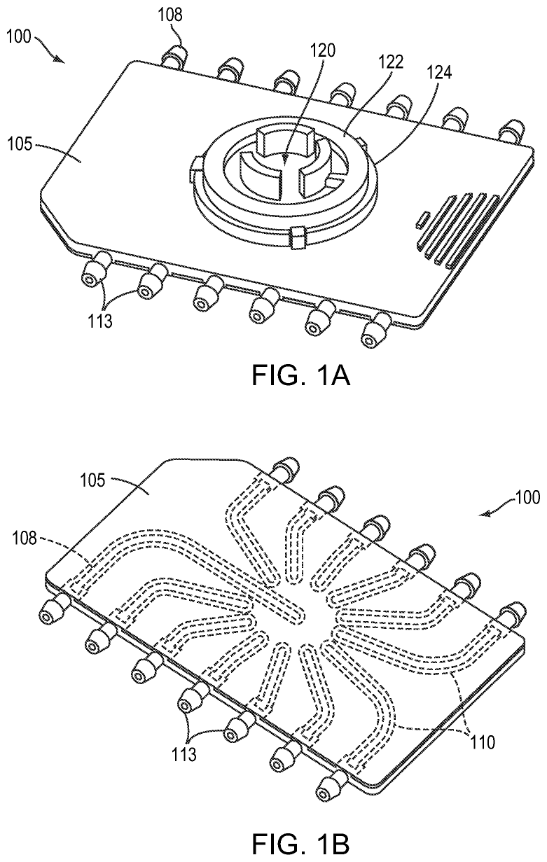

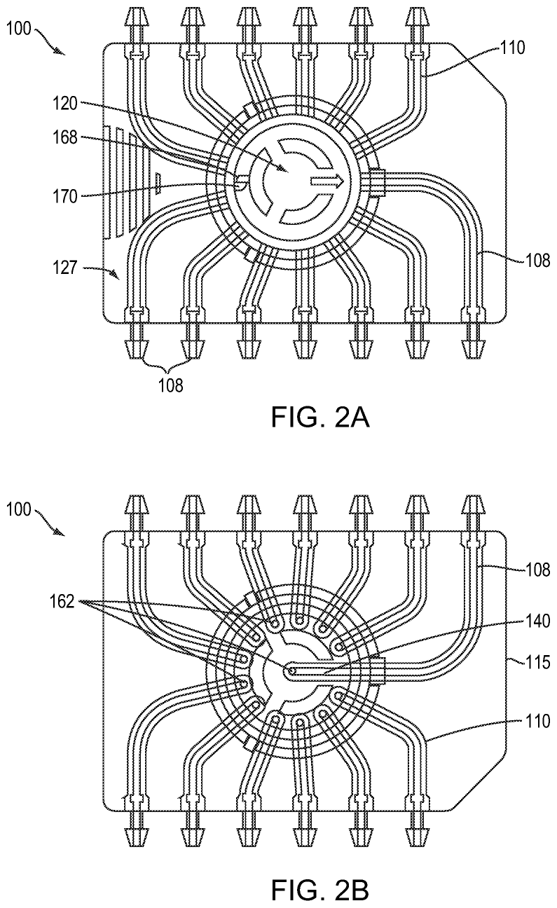

Refer first to FIGS. 1A-2B, which show a selectable fluid coupler in a cartridge configuration. The cartridge 100 comprises a flat, rigid body member 105 having therein a series of internal fluid channels including an inlet channel 108 and a plurality of outlet channels representatively indicated at 110. Each of the channels 108, 110 has a distal end terminating in a connector 113. Each of the connectors 113 has a receiving end over which a flexible tube conduit (not shown) may be force-fitted or overmolded to form a fluid seal. As is conventional, this may be achieved by providing the outward-facing ends of the connectors 113 with one or more barbs, flanges, bevels, or other engagement members. Alternatively, one or more of the connectors may be capped, e.g., with a removable (e.g., elastomeric) hood or permanent cover or plug affixed by glue, heat sealing or direct molding. A backplate 115, which may be transparent, overlies the body member 105 and seals the fluid channels 108, 110. The body member 105 and backplate 115 may be fabricated from any suitable durable, solid, nonporous material such as stainless steel or other metal, or (more typically) a highly crosslinked polymer such as a polycarbonate, a polypropylene or a polysulfone. Disposable fluidic tube conduits often comprise or consist of biocompatible materials such as silicone tubing or other plastics.

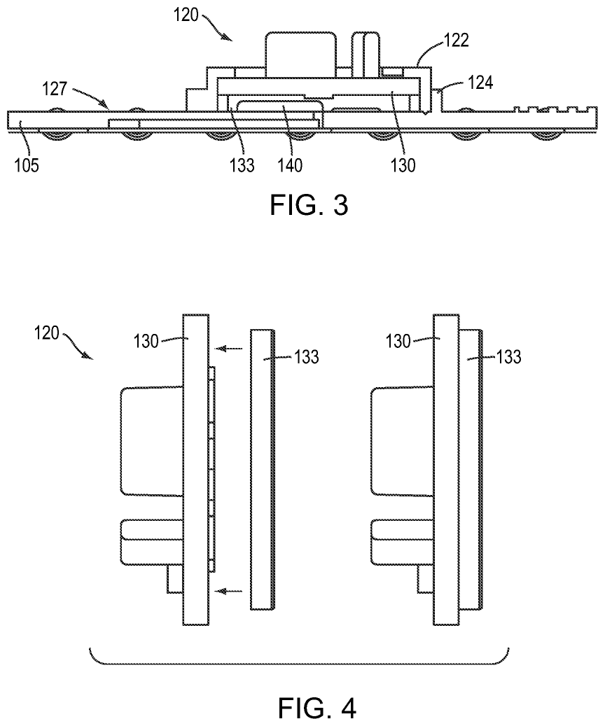

A valve head 120 is rotatively retained within a clamp 122. As shown in FIG. 1A and the sectional view of FIG. 3, the clamp 122 is firmly bonded to the top surface 127 of the body member 105 and may penetrate the surface 127 for stability. If necessary to prevent fluid leakage, a polymer skirt or a bead of adhesive can be applied to the joint where the clamp 122 meets the surface 127.

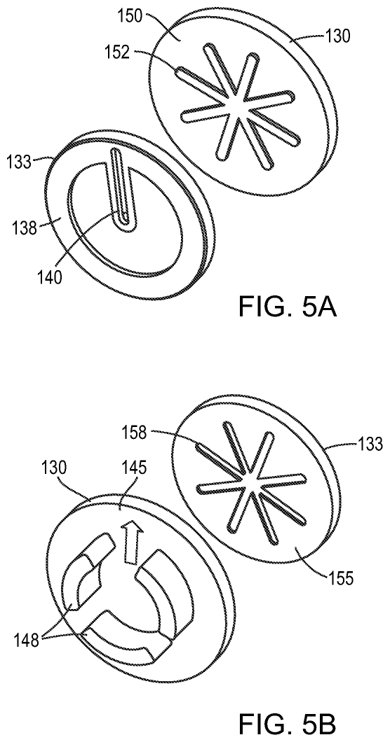

With reference to FIGS. 3-5B, the rotary valve head 120 may consist of or comprise two components, an engagement member 130 and, affixed thereto, a distributor 133. As best seen in FIGS. 5A and 5B, the outward-facing surface 138 of the distributor 133 includes a coupling channel 140. The outward-facing surface 145 of the engagement member 130 includes a plurality of arcuate ribs 148 and, if desired, a visual signal such as an arrow overlying the coupling channel 140. The engagement member 130 may be molded from a rigid polymer such as polybutyrene terephthalate (PBT), polycarbonate, an epoxy, or an injection-molding polymer. It should be strong enough to allow insertion of a torque fixture around and spanning the ribs 148 (e.g., having a Y configuration) to rotate the valve head 120 within the clamp 122. Because of the need to prevent fluid leakage, the valve head 120 is retained snugly within the clamp 122 as shown in FIG. 3, so that it may be necessary to apply, manually or by automated means, appreciable torque to rotate the valve head 120. Also for this reason, the distributor 133, which selectively directs the flow of fluid based on its angular position (as described below), is desirably formed from an elastomeric biocompatible polymer such as silicone or rubber. The engagement member 130 and distributor 133 are joined using any suitable means such as adhesive or molding the distributor 133 directly onto the engagement member 130. To prevent relative rotation therebetween, one of the components 130, 133 has a raised off-round pattern and the other component has a complementary well for receiving the raised pattern. In the illustrated embodiment, the inward-facing surface 150 of the engagement member 130 includes a raised star-shaped pattern 152, and the inward-facing surface 155 has a complementary star-shaped recession 158. It should be stressed, however, that the valve head 120 may alternatively be fabricated as a unitary piece from a single material.

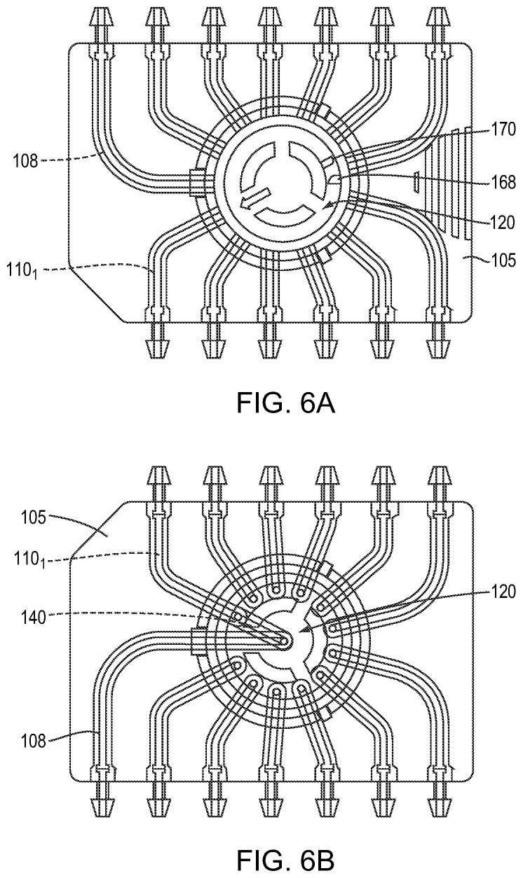

As shown in FIGS. 2A and 2B, the radially proximal end of each of the channels 108, 110 terminates in an aperture 162 opening to the surface 127 of the body member 105. These apertures 162 are covered by the distributor 133. In particular, the end of the coupling channel 140 at the center of the distributor 133 (see FIG. 5A) overlies the aperture of the inlet channel 108; the opposite end of the coupling channel 140 overlies the aperture of whichever outlet channel 110 it is aligned with. As a result, fluid communication between the inlet channel 108 and any selected outlet channel 1101 may be established by rotating the valve head 120 until the proper alignment is achieved as shown in FIGS. 6A and 6B. The bottom surface of the elastomeric distributor 133, held against the body member 105 by the clamp 122, seals the unselected apertures against leakage.

Particularly in connection with automated fixtures that rotate the valve head 120, it may be desirable to include, in the clamp 122, a detent 168 that stops rotation of the valve head 120 when it encounters a tab 170 extending radially along the surface of the engagement member 130 to its outer peripheral edge, thereby preventing rotation over more than a single revolution. As shown in FIGS. 2A and 2B, with the tab 170 butted against the detent 168, the coupling channel 140 overlies the inlet channel 108—that is, the valve is turned off and there is no fluidic connection to any outlet path.

An automated fixture or operating unit for operating the valve assembly 100 may include a head with features that engage the valve head 120, e.g., a Y-shaped set of ridges that pass between the arcuate ribs 148 (see FIG. 5B) for rotative engagement. In operation, fluidic tube conduits are coupled to the input connector and one or more output connectors 113. The operating unit selects (or an operator commands) one of the outlet conduits 110, and rotates the valve head 120 until a fluid path is established between the input conduit 108 and the selected output conduit 110. At this point, the operating unit may signal a pump, valve or other fluid-transfer device to transfer fluid to the valve assembly 100 and thereupon through the selected output conduit.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A valve assembly comprising:
a support;
an input fluid conduit passing through the support and terminating therein at a multiposition valve head; and
a plurality of output fluid conduits emanating from and individually selectable by the valve head for coupling to the input fluid conduit,
wherein the valve head comprises a rotatable member and a clamp seated within the support, the rotatable member being rotatable within the clamp over a fixed angular extent, various angular positions of the rotatable member each coupling the input fluid conduit to a different one of the output fluid conduits.

2. The valve assembly of claim 1, further comprising a surface seal surrounding a peripheral edge of the clamp where it meets the support.

3. The valve assembly of claim 1, wherein the rotatable member comprises a rigid engagement member and, affixed thereto, an elastomeric distributor including a recessed coupling channel for coupling the input fluid conduit to a selected output fluid conduit.

4. The valve assembly of claim 3, wherein the rotatable member and the elastomeric distributor include complementary raised and recessed features to prevent relative rotation therebetween.

5. The valve assembly of claim 4, wherein the features preventing relative rotation are off-round.

6. The valve assembly of claim 4, wherein the features preventing relative rotation are polygonal.

7. The valve assembly of claim 5, wherein the features preventing relative rotation are star-shaped.

8. The valve assembly of claim 3, wherein the engagement member comprises a plurality of arcuate engagement ribs.

9. The valve assembly of claim 1, wherein the rotatable member and the clamp include complementary engagement features for stopping rotation of the rotatable member at a fixed position.

10. The valve assembly of claim 9, wherein the fixed angular extent is no greater than a single revolution.

11. The valve assembly of claim 1, further comprising coupling members for coupling elastomeric tubes to the input and output fluid conduits.

12. A method of establishing fluid communication between a selected pair of elastomeric fluidic tube conduits, the method comprising the steps of:
providing a valve assembly including a support, a coupling member for an input fluid conduit passing through the support and terminating therein at a multiposition valve head, and coupling members for a plurality of output fluid conduits emanating from and individually selectable by the valve head for coupling to the input fluid conduit, wherein the valve head comprises a rotatable member and a clamp seated within the support;
coupling a first fluidic tube conduit to the input coupling member;
coupling a second fluidic tube conduit to a selected one of the output fluid conduit coupling members;
rotatively engaging an operating unit with the rotatable member;
rotating, by the operating unit, the rotatable member to an angular position coupling the input fluid conduit to the selected output fluid conduit; and
causing transfer of a fluid from the first fluidic tube conduit to the second fluidic tube conduit via the valve assembly.

13. The method of claim 12, wherein the rotatable member comprises a rigid engagement member and, affixed thereto, an elastomeric distributor including a recessed coupling channel for coupling the input fluid conduit to a selected output fluid conduit.

14. The method of claim 13, wherein the rotatable member and the elastomeric distributor include complementary raised and recessed features to prevent relative rotation therebetween.

15. The method of claim 14, wherein the features preventing relative rotation are off-round.

16. The method of claim 16, wherein the features preventing relative rotation are star-shaped.

17. The method of claim 13, wherein the engagement member comprises a plurality of arcuate engagement ribs.

18. The method of claim 12, wherein the rotatable member and the clamp include complementary engagement features for stopping rotation of the rotatable member at a fixed position.

19. The method of claim 18, wherein rotation is stopped after no more than a single revolution.
